(19) United States
(12) Patent Application Publication
(10) Pub. No.: US 2026/0004763 A1
(43) Pub. Date: Jan. 1, 2026

(54) ADAPTIVE BUILDING BASED ACTIVE NOISE CONTROL LOCATION

(71) Applicant: International Business Machines Corporation, Armonk, NY (US)

(72) Inventors: Christian Eggenberger-Wang, Wil (CH); Michael Egger, Niederwil (CH); Jörg Thomann, Schwoerstadt (DE); Domenic Largiadèr, Flawil (CH)

(73) Assignee: International Business Machines Corporation, Armonk, NY (US)

(21) Appl. No.: 18/759,980

(22) Filed: Jun. 30, 2024

(51) Int. Cl. G10K 11/178; G06F 40/58

(52) U.S. Cl. CPC G10K 11/17823; G10K 11/17881; G06F 40/58; G10K 11/17825; G10K 2210/12; G10K 2210/3011; G10K 2210/3026; G10K 2210/3027; G10K 2210/3028; G10K 2210/3056; G10K 2210/3215

(57) ABSTRACT

An embodiment detects, using a sensor installed within a building, a first position of a first noise source. The embodiment generates a first noise control configuration comprising a first directional acoustic loudspeaker and a first frequency and first amplitude of a first acoustic tone, the first frequency and first amplitude of the first acoustic tone, when generated by the first directional acoustic loudspeaker, selected to attenuate the first noise source at a first distance from the first position. The embodiment generates, according to the first noise control configuration, the first acoustic tone.

### BACKGROUND

The present invention relates generally to noise control. More particularly, the present invention relates to a method, system, and computer program for an adaptive building based active noise control location.

Passive noise control is sound reduction using sound-absorbing materials such as insulation, sound-absorbing tiles, or a muffler. For example, walls, in some cases incorporating additional sound-absorbing material, typically reduce the sound escaping from within a private office or conference room. As another example, headphones fitted around a wearer's ears can incorporate sound-absorbing material to reduce the amount of outside noise reaching the wearer. However, closed offices and conference rooms are expensive to build, are not easily adaptable to changing circumstances (e.g., a meeting with more attendees than can comfortably fit into an available room), block others' enjoyment of other building features (e.g., ventilation from an open window or door, or a view through a window or of art or a building's architecture), and the closed door of an office or conference room can be off-putting to others. Headphones, due to their weight and clamping force on the wearer's ears, are often uncomfortable to wear for any length of time, and impose a burden not on a source of unwanted noise but on a recipient. As well, neither solution is effective at reducing the noise from a moving noise source (e.g., a robot vacuum cleaner).

Active noise control, also known as noise cancellation or active noise reduction, refers to reducing unwanted sound by the addition of a second sound specifically designed to cancel the unwanted sound. In particular, because sound is a pressure wave, active noise control involves analyzing the waveform of an unwanted noise, and generating a signal with a phase shift or an inverted polarity from the original signal, and an amplitude directly proportional to the amplitude of the original waveform. Where the two sound waves meet, destructive interference between the two sound waves cancels out much or all of the perceived volume of the unwanted noise.

Active noise control is typically incorporated into headphones, to reduce or eliminate noise (such as from the outside world) a headphone wearer does not want to listen to. Active noise control is also typically incorporated into a telephone microphone implemented in a mobile device, to reduce transmission of noise other than a device user's voice. However, a user of active-noise-control headphones tends to speak louder than normal, disturbing those around the user or allowing others to hear a private conversation. Active-noise-control headphones can also isolate a user from important sounds (e.g., an oncoming car). As well, in some devices, a built-in microphone used to implement active noise control can be used to monitor or record a user's speech without permission. Device-based active noise control also requires use of a power source, such as a battery, and typically requires that each user have his or her own personal device, adding to a noise control solution's expense. As well, active noise control requires a consistent geometric relationship between the noise source being controlled and the second signal doing the controlling, so is not a good solution for a noise source that moves relative to a noise control implementation.

Thus, the illustrative embodiments recognize that there is a need for an active noise control implementation that is adaptable to open-plan offices and other indoor spaces, is reconfigurable in real time to adapt to changing numbers of meeting participants or a moving noise source, and is optionally invisible.

### SUMMARY

The illustrative embodiments provide for an adaptive building based active noise control location. An embodiment includes detecting, using a sensor installed within a building, a first position of a first noise source. An embodiment includes generating a first noise control configuration comprising a first directional acoustic loudspeaker and a first frequency and first amplitude of a first acoustic tone, the first frequency and first amplitude of the first acoustic tone, when generated by the first directional acoustic loudspeaker, selected to attenuate the first noise source at a first distance from the first position. An embodiment includes generating, according to the first noise control configuration, the first acoustic tone. Other embodiments of this aspect include corresponding computer systems, apparatus, and computer programs recorded on one or more computer storage devices, each configured to perform the actions of the embodiment. Thus, the embodiment provides an adaptive building based active noise control location.

In another embodiment, the first noise control configuration comprises a conference area enclosed by a sound wall, the sound wall formed using a line of directional acoustic loudspeakers including the first directional acoustic loudspeaker, the line of directional acoustic loudspeakers selected from a set of directional acoustic loudspeakers installed within the building. Thus, the embodiment provides an adaptive building based active noise control location including a conference area.

Another embodiment further includes detecting, using a microphone, audio within a first portion of the conference area; and transmitting, using a first directional ultrasonic loudspeaker, the audio to a second portion of the conference area. Thus, the embodiment provides an adaptive building based active noise control location including details of the conference area.

Another embodiment further includes translating, using a trained machine translation model, the audio to a second language, the translating resulting in translated audio; and transmitting, using a second directional ultrasonic loudspeaker, the translated audio to a third portion of the conference area. Thus, the embodiment provides an adaptive building based active noise control location including details of the conference area.

In another embodiment, the first noise control configuration comprises a noise attenuation area within a sound footprint of the first directional acoustic loudspeaker. Thus, the embodiment provides an adaptive building based active noise control location including a noise attenuation area.

Another embodiment further includes detecting, using the sensor, that the first noise source has moved to a second position; generating, responsive to the detecting, a second noise control configuration comprising a second directional acoustic loudspeaker and a second frequency and second amplitude of a second acoustic tone, the second frequency and second amplitude of the second acoustic tone, when generated by the second directional acoustic loudspeaker, selected to attenuate the first noise source at a second distance from the second position; and generating, according to the second noise control configuration, the second acoustic tone. Thus, the embodiment provides additional detail of an adaptive building based active noise control location.

Another embodiment further includes detecting, using the sensor, that the first noise source has altered by more than a specified amount, the altering resulting in a second noise source at the first position; generating, responsive to the detecting, a third noise control configuration comprising the first directional acoustic loudspeaker and a third frequency and third amplitude of a third acoustic tone, the third frequency and third amplitude of the third acoustic tone, when generated by the first directional acoustic loudspeaker, selected to attenuate the second noise source at a third distance from the first position; and generating, according to the third noise control configuration, the third acoustic tone. Thus, the embodiment provides additional detail of an adaptive building based active noise control location.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a block diagram of an example configuration for an adaptive building based active noise control location in accordance with an illustrative embodiment;

FIG. 3 depicts a top view of an example configuration for an adaptive building based active noise control location in accordance with an illustrative embodiment;

FIG. 4 depicts a side view of an example configuration for an adaptive building based active noise control location in accordance with an illustrative embodiment;

FIG. 5 depicts example loudspeakers used in example configuration for an adaptive building based active noise control location in accordance with an illustrative embodiment;

FIG. 6 depicts example loudspeakers used in example configuration for an adaptive building based active noise control location in accordance with an illustrative embodiment;

FIG. 7 depicts example loudspeakers used in example configuration for an adaptive building based active noise control location in accordance with an illustrative embodiment; and

FIG. 8 depicts a flowchart of an example process for an adaptive building based active noise control location in accordance with an illustrative embodiment.

### DETAILED DESCRIPTION

The illustrative embodiments recognize that there is a need for an active noise control implementation that is adaptable to open-plan offices and other indoor spaces, is reconfigurable in real time to adapt to changing numbers of meeting participants or a moving noise source, and is optionally invisible.

The present disclosure addresses the deficiencies described above by providing a process (as well as a system, method, machine-readable medium, etc.) that detects, using a sensor installed within a building, a first position of a first noise source; generates a first noise control configuration selected to attenuate the first noise source at a first distance from the first position; and generates, according to the first noise control configuration, a first acoustic tone. Thus, the illustrative embodiments provide for an adaptive building based active noise control location.

An illustrative embodiment receives building configuration data. The building configuration data includes data of one or more sensors installed within a building or movable structure (e.g., an airplane, bus, or passenger train), such as the sensor type, position within the building or structure, access information, sensor data format, and the like. Some non-limiting examples of sensors installed within the building are microphones, frequency spectrum analyzers, cameras, Radio Frequency Identification (RFID) readers, Bluetooth Low Energy (BLE) recorders, Wi-Fi access points and other devices including a radio antenna, and other sensors capable of determining a user's or object's location using a RFID tag, a BLE beacon, or a similar tag using a different technology, distance meters using ultrasonic sound or infrared light, atmospheric condition sensors such as temperature, humidity, and wind sensors, and light sensors. (Bluetooth is a registered trademark of Bluetooth SIG, Inc. in the United States and other countries.)

The building configuration data also includes data of one or more directional acoustic loudspeakers installed within the building, such as a directional acoustic loudspeaker's position within the building and information an embodiment can use to configure a directional acoustic loudspeaker. If the building includes one or more directional ultrasonic loudspeakers, the building configuration data also includes data of the directional ultrasonic loudspeakers, such as a directional ultrasonic loudspeaker's position within the building and information an embodiment can use to configure the directional ultrasonic loudspeaker. A directional ultrasonic loudspeaker modulates ultrasonic waves, which are inaudible to humans, so that the ultrasonic waves are converted into audible sound waves when the ultrasonic waves hit a surface of an object or a person, allowing audible sound to be directed to a specific point or area without disturbing the surrounding area. A directional acoustic loudspeaker uses one or more acoustic metamaterial surfaces arranged at defined distances to achieve a defined acoustical beam with a specific focal length and direction, similar to how optical lenses adjust light waves. In contrast to the sound emitted by a directional ultrasonic loudspeaker, the sound emitted by a directional acoustic loudspeaker is audible to humans. An acoustic metamaterial is a material designed to control, direct, and manipulate sound waves or phonons in gases, liquids, and solids (crystal lattices), by manipulating parameters such as the bulk modulus β, density p, and chirality of a portion of the material. An acoustic metamaterial can be configured to channel acoustic sound into a particular kind of beam, analogously to a lens's function in channeling light.

If the building includes one or more conference areas (from which unwanted noise might require attenuation) or quiet areas (within which noise might require attenuation), or other designated noise control locations, the building configuration data also optionally includes location and capacity data of the locations. If the building includes one or more light sources usable to indicate a location and status of a noise control location, the building configuration data also includes data of the light sources, such as a light source's position within the building and information an embodiment can use to configure the light source.

An embodiment uses a sensor, or a combination of sensors, installed within a building or movable structure to detect a first position of a first noise source to which active noise control is to be applied. The first position is a location within the building. For example, an embodiment might use a microphone and knowledge of where the microphone is located to detect that there are users speaking in a particular conference area, or an embodiment might use a group of microphones, at known locations on a particular floor of a building, to detect that a robot vacuum cleaner is cleaning and moving on that floor. In one embodiment, the first position includes a height of the noise source above a floor or below a ceiling, for use in improving noise control precision. An embodiment also uses a sensor, or a combination of sensors, installed within a building or movable structure to detect loudness, or amplitude, of the noise source. For example, if there are three users in a designated conference area, an embodiment might detect that the first person speaks at 50 dB (A) average and is 2 meters from a boundary of the conference area, the second speaks at 60 dB (A) average and is 1 meter from the same boundary, and the third speaks at 65 dB (A) average and is 2 meters from the same boundary. An embodiment also uses a sensor, or a combination of sensors, installed within a building or movable structure to detect a frequency or frequency characteristic (e.g., average frequency, frequency distribution or variation over time) of the noise source. For example, some human voices are lower frequency than others, and mechanical and artificially generated sounds (e.g., a fan, the beeps of a robot) also differ from each other. One embodiment also uses a sensor, or a combination of sensors, installed within a building or movable structure to detect a direction or radiation characteristic of the noise source (e.g., does the noise radiate outward spherically, or projected in a particular direction).

An embodiment uses a sensor, or a combination of sensors, installed within a building or movable structure to detect an acoustic condition surrounding the detected noise source. An acoustic condition is a condition that affects propagation of sound within an area. Some examples of an acoustic condition are the temperature and humidity within an area, and the number and locations of objects and the objects' sound reflectivity or absorption characteristics. For example, temperature and humidity affect the speed of sound in air, and carpet absorbs some sound while a hard floor can reflect sound.

An embodiment generates a noise control configuration based on the acoustic condition. The noise configuration includes a directional acoustic loudspeaker, as well as a frequency and amplitude of an acoustic tone that, when generated by the directional acoustic loudspeaker in the acoustic condition, attenuate the detected noise source at a particular distance from the position of the detected noise source. In particular, given the lateral position and height of a noise source and the speed of sound in the current environment, an embodiment selects one or more directional acoustic loudspeakers at a particular distance from the noise source, and generates an acoustic tone that, when intersecting sound from the noise source, attenuates or cancels out the noise source at the intersection, masks the noise source from being heard at a particular distance from noise source, or uses a hybrid approach.

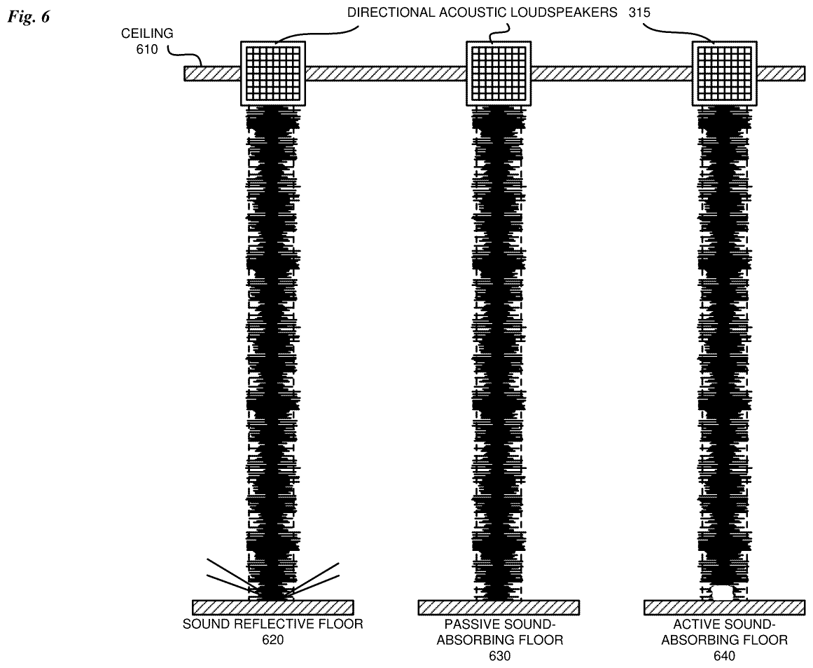

One embodiment uses active noise cancellation, a presently available technique. However, the noise cancelling effect of active noise cancellation decreases as the angle between the counter waves and the main direction of the external noise increases, because the counter waves are most effective when they are precisely opposite to the external noise waves, allowing for optimal interference and cancellation (illustrated in FIG. 6).

Another embodiment uses spectral subtraction in combination with loudness. Spectral subtraction is a presently available technique used for noise reduction in audio signals, that works by estimating the noise spectrum from the background noise in a signal and then subtracting this estimated noise spectrum from the noisy signal spectrum to enhance the desired signal, helping to improve the signal-to-noise ratio and making the desired signal more prominent in the noisy environment.

Another embodiment uses noise cancellation using shaping in combination with loudness. Noise cancellation using shaping, a presently available technique, works by creating a spectrally-shaped reference signal that is subtracted from the input signal to reduce the noise. To create the spectrally-shaped reference signal, the technique estimates the noise spectrum from the input signal, then creates a reference signal that is shaped to cancel out the noise spectrum. The reference signal is typically created by filtering the input signal with a filter that has the inverse of the noise spectrum. The process is repeated over time to continuously update the reference signal and reduce the noise in the input signal. Spectral subtraction only uses the noise spectrum from the input signal to create the reference signal, while noise cancellation using shaping uses a reference signal that is shaped to cancel out the noise spectrum. This means that noise cancellation using shaping can achieve better noise reduction than spectral subtraction, especially in cases where the noise spectrum is not constant over time.

Another embodiment uses an adaptive filtering approach. Adaptive filtering is a presently available noise cancellation technique that uses an adaptive filter to continuously update the filter coefficients based on the input signal and an error signal. The adaptive filter generates a reference signal that is subtracted from the input signal to reduce noise. The error signal, which is the difference between the input signal and the reference signal, is used to adjust the filter coefficients to minimize the error. Adaptive filtering can achieve better noise reduction than noise cancellation using shaping and spectral subtraction, especially in non-stationary noise environments. Adaptive filtering continuously updates the filter coefficients to adapt to changing noise conditions, whereas noise cancellation using shaping and spectral subtraction assume a fixed noise spectrum. Adaptive filtering can effectively cancel out interference signals that are not stationary, whereas noise cancellation using shaping and spectral subtraction may not perform well in such cases. Adaptive filtering can be used in a wide range of applications, including speech enhancement, echo cancellation, and noise reduction in audio and biomedical signals. Thus, adaptive filtering can achieve superior performance compared to noise cancellation using shaping and spectral subtraction, especially in dynamic and non-stationary noise environments.

Another embodiment selects a noise cancellation approach according to the use case and the desired outcome. For example, to protect a conversation from others outside the conversation, the embodiment might use a masking approach. However, to avoid disturbing noises like from a vacuum cleaner or a coffee machine, the embodiment might use active noise cancelling approach. Another embodiment combines techniques depending on the building, the sources of noise and other influencing factors.

As a noise masking example, if there are three users in a designated conference area, the first person speaks at 50 dB (A) average and is 2 meters from a boundary of the conference area, the second speaks at 60 dB (A) average and is 1 meter from the same boundary, and the third speaks at 65 dB (A) average and is 2 meters from the same boundary, the total sound level intensity is 62.6 dB (A). If the generated sound baffle has an amplitude at least 10 dB (A) higher than the sound emitted by the current conversation, then the contribution of the conversation level to the total sound level is sufficiently negligible as to be masked. As well, if the generated acoustic tone has a net amplitude of 72.6 dB (A), when the emissions from the conversation are mixed with that of the generated tone the total amplitude is increased by only 0.4 dB (A). One embodiment includes a configurable maximum generated acoustic tone volume or a configurable maximum total sound volume, for example 85 dB (A) (based on worker sound exposure limits during the course of a workday).

An embodiment selects one or more directional acoustic loudspeakers, as well as a configuration for each directional acoustic loudspeaker, based on a desired geometry of the noise attenuation, as gaps in the noise attenuation allow unwanted sounds to seep through. One approach is to use directional acoustic loudspeakers emitting a vertical sound “beam” (by analogy from optics). Thus, a directional acoustic loudspeaker, installed in a ceiling and emitting a constant-diameter sound “beam” towards a corresponding floor, forms as an example a sound zone that is a circular or elliptical cylinder. To form a vertical plane or virtual wall, an embodiment selects a line of directional acoustic loudspeakers with no or minimal gaps between elliptical cylinders. In another approach, directional acoustic loudspeakers with a sound “beam” that is wider at the bottom than at the source of the sound, can be spaced further apart than vertical directional acoustic loudspeakers, because the acoustic beam paths of adjacent loudspeakers overlap each other, helping to close gaps. A grid or several grids arranged behind each other, equipped with fixed-position metamaterial bricks, or a zoom system in which the distance of several grids can be changed relative to each other depending on the desired geometry, can be used to generate a sound “beam” that is wider at the bottom than at the source of the sound, In one embodiment, individual directional acoustic loudspeakers, or individual metamaterial portions of a loudspeaker, are rotatable to alter the size, direction, and ellipse focal points, of the sound “beam” emitted by each directional acoustic loudspeaker. To form a sound wall, an embodiment selects particular directional acoustic loudspeakers that are between a minimum and maximum distance from each other. The minimum or maximum distance between directional acoustic loudspeakers depends on the height of each loudspeaker relative to the height of the noise source, the amplitude of the acoustic tone and the sharpness or blurring of the sound “beam” over a transition area where the acoustic tone is still heard with decreasing volume (e.g., a few millimeters or centimeters), reflection of the acoustic tone by the ceiling or floor, frequency spectrum and amplitude of the acoustic tone, as well as other factors.

One example of a noise control configuration is a conference area enclosed by one or more invisible sound attenuation planes (i.e., baffles, sound walls, or virtual walls), each formed using a line of directional acoustic loudspeakers in a manner described herein. In one embodiment, a conference area has a static position, optionally including floor markings, light beams delineating the conference area to participants, or a status indicator indicating that noise attenuation is on or off. Another embodiment forms a conference area when triggered by one or more users speaking at a particular location for longer than a particular amount of time, for example when users gather near someone's desk for an impromptu conversation.

Another example of a noise control configuration is a noise attenuation area that fits within the sound footprint of one or a small number of directional acoustic loudspeakers (e.g., to attenuate the noise of a printer, coffee machine, ringing telephone, or a co-worker who listens to music while working). In one embodiment, the noise attenuation area is static. In another embodiment, the noise attenuation area moves with the noise source (e.g., to attenuate the noise of a robot vacuum cleaner or a pacing-while-speaking co-worker).

An embodiment generates an acoustic tone according to a noise control configuration, in a manner described herein, thus attenuating a detected noise source.

If an embodiment detects that the noise source has altered by more than a predetermined amount (e.g., a new user has entered a conference area, an existing user has left a conference area, a conversation being attenuated has grown louder or quieter, or a moving noise source has moved to a location under a different directional acoustic loudspeaker), an embodiment adjusts the existing noise control configuration and the generated acoustic tone accordingly. If an embodiment detects that the noise source now has an amplitude below a predetermined threshold, an embodiment ceases generating the acoustic tone.

An embodiment analyzes sound outside a noise control area, to determine in real time which frequencies are needed, how high the sound level intensity must be for each added frequency, and the width of the acoustic baffle in order to achieve the desired masking effect. To adapt to changing environmental noise, some embodiments use one or more presently available neural network based techniques. One embodiment uses a trained Recurrent Neural Network (RNN) or Long Short-Term Memory (LSTM) network to predict future noise conditions based on past data, enabling proactive noise masking even in environments where noise levels and types vary. Another embodiment uses one or more natural language processing (NLP) techniques adapted to improve understanding of different types of noise through feature extraction and semantic analysis. Another embodiment uses a reinforcement learning technique to learn the optimal parameterization for effective noise masking based on feedback from users and environmental changes (e.g., more humid, warmer air in the summer months, drier, cooler air in the winter months, air conditioning maintenance).

Loud, usually abrupt, noise source changes (e.g., shouting, clapping, or a loud argument) might not be sufficiently attenuated or masked by an embodiment. As well, a user near a sound wall might have difficulty hearing a speaker elsewhere in a conference area due to the sound of the sound wall. Thus, one embodiment uses a microphone (e.g., a directional beam microphone), to detect audio in a particular portion of a conference area and transmits detected audio to another portion of the conference area using a directional ultrasonic speaker directly above the portion. Thus, in a large multi-participant conference area, a speaker is heard equally by all participants, regardless of distance from the speaker. One or more microphones can also be turned on or off, by a user, speaker, or automatically in response to a trigger event, for example to prevent one user's private comments from being transmitted elsewhere). Another embodiment uses a presently available trained machine translation model to translate detected audio into another language and transmits the translated audio to another portion of the conference area using a directional ultrasonic speaker directly above the portion. Another embodiment transmits detected or translated audio to a remote participant. One embodiment indicates that a microphone is actively detecting and transmitting audio using a change in the light color of the ceiling or floor lighting, or in the noise control area itself. One embodiment includes an ability to disable transmission of detected or translated audio, for privacy or other reasons.

One embodiment has access to data of a building management system, for use in managing conference and quiet zones. In the building management system, zones can be categorized as conference zone versus quiet zone, a particular type of conference zone (e.g., one for speaking and one for shouting or music), reserved versus ad-hoc (e.g., smartphone cocoon) zone, whether a zone has a static position or is moving, whether and how a zone's size is adjustable. Times of use for zones that are reserved in advance are also configurable in the building management system. The building management system uses defined confidentiality levels to indicate to an embodiment whether, for example, priority is given to speech masking (using a higher-volume sound wall) or comfort (using a lower-volume sound level, potentially reducing effective noise attenuation). The building management system contains data about registered users, for example a user's hearing or color vision disorder or preference to be considered when configuring lighting and an acoustic tone. A user profile can also include a user's acoustic fingerprint, a combination of features that characterize a user's voice, such as pitch, timbre, volume, and speaking rate, improving the efficiency and effectiveness of masking a conversation. The building management system contains data about total power consumption of noise control areas for billing purposes and to analyze and illustrate optimization potential. For example, the electricity consumption of a noise control area with a high confidentiality level will tend to be higher than that of a noise control area that is oriented towards user comfort. The building management system contains data about zone dimensions layout, and user capacity, characteristics of the room acoustics under different conditions, zone positioning (e.g., for providing “corridors” so that people and physical objects (e.g., pallets) outside a noise control area can move or be moved from one position to another without going through a noise control area), lighting conditions used to prevent people outside a noise control area from seeing private information (e.g., lip movements, gestures, slides, holograms) and whether and how a noise control area boundary should be illuminated. The building management system contains data specifying one or more installation-specific policies, such as the light color or sound indicating a noise control area boundary, a warning, a noise control area status, a maximum sound volume, what type of data is stored for what period of time, and which entities are allowed to access what level of aggregation for what purpose, minimum distances between users. The building management system also stores sensor data (e.g., from a camera or microphone) that helps determine a maintenance status of a portion of the building (e.g., dirt, dripping water, abnormal noise from the coffee machine) and, based on maintenance priorities and the layout and position of noise control areas, determines where, when and for how long robots or technicians can fix problems without disturbing people in noise control areas.

One embodiment uses one or more presently available techniques to create, optimize, and manage noise control areas with as little overlap in time and space as possible, while complying with defined building-specific requirements. For example, Linear Programming (LP), Mixed-Integer Programming (MIP), Mixed-Integer Quadratically Constrained Programming (MIQCP), Second-Order Cone Programming (SOCP), and scheduling are usable in solving multi-objective problems, e.g., when multiple, often conflicting objectives need to be optimized, such as changing team sizes with different requirements versus limited resources, or energy efficiency versus sound masking efficiency of a sound wall.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

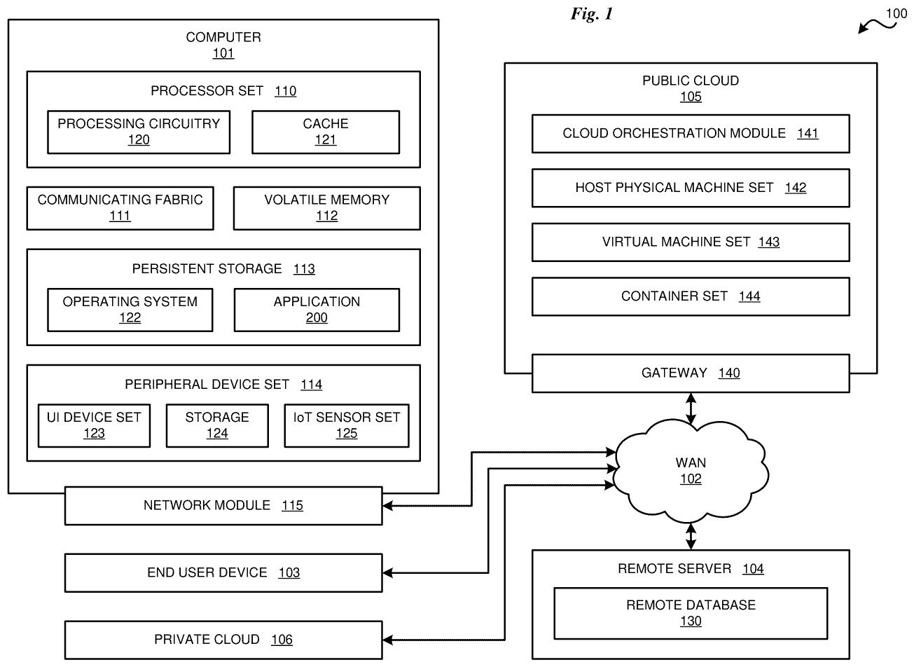

With reference to FIG. 1, this figure depicts a block diagram of a computing environment 100. Computing environment 100 contains an example of an environment for the execution of at least some of the computer code involved in performing the inventive methods, such as application 200 implementing an adaptive building based active noise control location. In addition to application 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and application 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in application 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

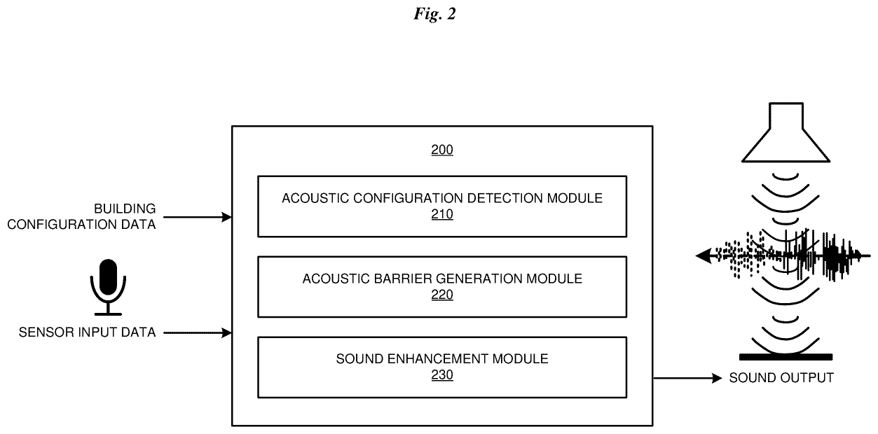

With reference to FIG. 2, this figure depicts a block diagram of an example configuration for an adaptive building based active noise control location in accordance with an illustrative embodiment. Application 200 is the same as application 200 in FIG. 1.

In the illustrated embodiment, application 200 receives building configuration data. The building configuration data includes data of one or more sensors installed within a building or movable structure (e.g., an airplane, bus, or passenger train), such as the sensor type, position within the building or structure, access information, sensor data format, and the like. Some non-limiting examples of sensors installed within the building are microphones, frequency spectrum analyzers, cameras, Radio Frequency Identification (RFID) readers, Bluetooth Low Energy (BLE) recorders, Wi-Fi access points and other devices including a radio antenna, and other sensors capable of determining a user's or object's location using a RFID tag, a BLE beacon, or a similar tag using a different technology, distance meters using ultrasonic sound or infrared light, atmospheric condition sensors such as temperature, humidity, and wind sensors, and light sensors.

The building configuration data also includes data of one or more directional acoustic loudspeakers installed within the building, such as a directional acoustic loudspeaker's position within the building and information an embodiment can use to configure a directional acoustic loudspeaker. If the building includes one or more directional ultrasonic loudspeakers, the building configuration data also includes data of the directional ultrasonic loudspeakers, such as a directional ultrasonic loudspeaker's position within the building and information an embodiment can use to configure the directional ultrasonic loudspeaker. A directional ultrasonic loudspeaker modulates ultrasonic waves, which are inaudible to humans, so that the ultrasonic waves are converted into audible sound waves when the ultrasonic waves hit a surface of an object or a person, allowing audible sound to be directed to a specific point or area without disturbing the surrounding area. A directional acoustic loudspeaker uses one or more acoustic metamaterial surfaces arranged at defined distances to achieve a defined acoustical beam with a specific focal length and direction, similar to how optical lenses adjust light waves. In contrast to the sound emitted by a directional ultrasonic loudspeaker, the sound emitted by a directional acoustic loudspeaker is audible to humans. An acoustic metamaterial is a material designed to control, direct, and manipulate sound waves or phonons in gases, liquids, and solids (crystal lattices), by manipulating parameters such as the bulk modulus β, density p, and chirality of a portion of the material. An acoustic metamaterial can be configured to channel acoustic sound into a particular kind of beam, analogously to a lens's function in channeling light.

If the building includes one or more conference areas (from which unwanted noise might require attenuation) or quiet areas (within which noise might require attenuation), or other designated noise control locations, the building configuration data also optionally includes location and capacity data of the locations. If the building includes one or more light sources usable to indicate a location and status of a noise control location, the building configuration data also includes data of the light sources, such as a light source's position within the building and information an embodiment can use to configure the light source.

Acoustic configuration detection module 210 uses a sensor, or a combination of sensors, installed within a building or movable structure to detect a first position of a first noise source to which active noise control is to be applied. The first position is a location within the building. For example, module 210 might use a microphone and knowledge of where the microphone is located to detect that there are users speaking in a particular conference area, or module 210 might use a group of microphones, at known locations on a particular floor of a building, to detect that a robot vacuum cleaner is cleaning and moving on that floor. In one implementation of module 210, the first position includes a height of the noise source above a floor or below a ceiling, for use in improving noise control precision. Module 210 also uses a sensor, or a combination of sensors, installed within a building or movable structure to detect a loudness, or amplitude, of the noise source. For example, if there are three users in a designated conference area, module 210 might detect that the first person speaks at 50 dB (A) average and is 2 meters from a boundary of the conference area, the second speaks at 60 dB (A) average and is 1 meter from the same boundary, and the third speaks at 65 dB (A) average and is 2 meters from the same boundary. Module 210 also uses a sensor, or a combination of sensors, installed within a building or movable structure to detect a frequency or frequency characteristic (e.g., average frequency, frequency distribution or variation over time) of the noise source. For example, some human voices are lower frequency than others, and mechanical and artificially generated sounds (e.g., a fan, the beeps of a robot) also differ from each other. One implementation of module 210 also uses a sensor, or a combination of sensors, installed within a building or movable structure to detect a direction or radiation characteristic of the noise source (e.g., does the noise radiate outward spherically, or projected in a particular direction).

Module 210 uses a sensor, or a combination of sensors, installed within a building or movable structure to detect an acoustic condition surrounding the detected noise source. An acoustic condition is a condition that affects propagation of sound within an area. Some examples of an acoustic condition are the temperature and humidity within an area, and the number and locations of objects and the objects' sound reflectivity or absorption characteristics. For example, temperature and humidity affect the speed of sound in air, and carpet absorbs some sound while a hard floor can reflect sound.

Acoustic barrier generation module 220 generates a noise control configuration based on the acoustic condition. The noise configuration includes a directional acoustic loudspeaker, as well as a frequency and amplitude of an acoustic tone that, when generated by the directional acoustic loudspeaker in the acoustic condition, attenuate the detected noise source at a particular distance from the position of the detected noise source. In particular, given the lateral position and height of a noise source and the speed of sound in the current environment, module 220 selects one or more directional acoustic loudspeakers at a particular distance from the noise source, and generates an acoustic tone that, when intersecting sound from the noise source, attenuates or cancels out the noise source at the intersection, masks the noise source from being heard at a particular distance from noise source, or uses a hybrid approach.

One implementation of module 220 uses active noise cancellation, a presently available technique. However, the noise cancelling effect of active noise cancellation decreases as the angle between the counter waves and the main direction of the external noise increases, because the counter waves are most effective when they are precisely opposite to the external noise waves, allowing for optimal interference and cancellation (illustrated in FIG. 6).

Another implementation of module 220 uses spectral subtraction in combination with loudness. Spectral subtraction is a presently available technique used for noise reduction in audio signals, that works by estimating the noise spectrum from the background noise in a signal and then subtracting this estimated noise spectrum from the noisy signal spectrum to enhance the desired signal, helping to improve the signal-to-noise ratio and making the desired signal more prominent in the noisy environment.

Another implementation of module 220 uses noise cancellation using shaping in combination with loudness. Noise cancellation using shaping, a presently available technique, works by creating a spectrally-shaped reference signal that is subtracted from the input signal to reduce the noise. To create the spectrally-shaped reference signal, the technique estimates the noise spectrum from the input signal, then creates a reference signal that is shaped to cancel out the noise spectrum. The reference signal is typically created by filtering the input signal with a filter that has the inverse of the noise spectrum. The process is repeated over time to continuously update the reference signal and reduce the noise in the input signal. Spectral subtraction only uses the noise spectrum from the input signal to create the reference signal, while noise cancellation using shaping uses a reference signal that is shaped to cancel out the noise spectrum. This means that noise cancellation using shaping can achieve better noise reduction than spectral subtraction, especially in cases where the noise spectrum is not constant over time.

Another implementation of module 220 uses an adaptive filtering approach. Adaptive filtering is a presently available noise cancellation technique that uses an adaptive filter to continuously update the filter coefficients based on the input signal and an error signal. The adaptive filter generates a reference signal that is subtracted from the input signal to reduce noise. The error signal, which is the difference between the input signal and the reference signal, is used to adjust the filter coefficients to minimize the error. Adaptive filtering can achieve better noise reduction than noise cancellation using shaping and spectral subtraction, especially in non-stationary noise environments. Adaptive filtering continuously updates the filter coefficients to adapt to changing noise conditions, whereas noise cancellation using shaping and spectral subtraction assume a fixed noise spectrum. Adaptive filtering can effectively cancel out interference signals that are not stationary, whereas noise cancellation using shaping and spectral subtraction may not perform well in such cases. Adaptive filtering can be used in a wide range of applications, including speech enhancement, echo cancellation, and noise reduction in audio and biomedical signals. Thus, adaptive filtering can achieve superior performance compared to noise cancellation using shaping and spectral subtraction, especially in dynamic and non-stationary noise environments.

Another implementation of module 220 selects a noise cancellation approach according to the use case and the desired outcome. For example, to protect a conversation from others outside the conversation, the implementation might use a masking approach. However, to avoid disturbing noises like from a vacuum cleaner or a coffee machine, the implementation might use active noise cancelling approach. Another implementation of module 220 combines techniques depending on the building, the sources of noise and other influencing factors.

As a noise masking example, if there are three users in a designated conference area, the first person speaks at 50 dB (A) average and is 2 meters from a boundary of the conference area, the second speaks at 60 dB (A) average and is 1 meter from the same boundary, and the third speaks at 65 dB (A) average and is 2 meters from the same boundary, the total sound level intensity is 62.6 dB (A). If the generated sound baffle has an amplitude at least 10 dB (A) higher than the sound emitted by the current conversation, then the contribution of the conversation level to the total sound level is sufficiently negligible as to be masked. As well, if the generated acoustic tone has a net amplitude of 72.6 dB (A), when the emissions from the conversation are mixed with that of the generated tone the total amplitude is increased by only 0.4 dB (A). One implementation of module 220 includes a configurable maximum generated acoustic tone volume or a configurable maximum total sound volume, for example 85 dB (A) (based on worker sound exposure limits during the course of a workday).

Module 220 selects one or more directional acoustic loudspeakers, as well as a configuration for each directional acoustic loudspeaker, based on a desired geometry of the noise attenuation, as gaps in the noise attenuation allow unwanted sounds to seep through. One approach is to use directional acoustic loudspeakers emitting a vertical sound “beam” (by analogy from optics). Thus, a directional acoustic loudspeaker, installed in a ceiling and emitting a constant-diameter sound “beam” towards a corresponding floor, forms a sound zone that is a circular or elliptical cylinder. To form a vertical plane or virtual wall, an embodiment selects a line of directional acoustic loudspeakers with no or minimal gaps between elliptical cylinders. In another approach, directional acoustic loudspeakers with a sound “beam” that is wider at the bottom than at the source of the sound, can be spaced further apart than vertical directional acoustic loudspeakers, because the acoustic beam paths of adjacent loudspeakers overlap each other, helping to close gaps. A grid or several grids arranged behind each other, equipped with fixed-position metamaterial bricks, or a zoom system in which the distance of several grids can be changed relative to each other depending on the desired geometry, can be used to generate a sound “beam” that is wider at the bottom than at the source of the sound. In one embodiment, individual directional acoustic loudspeakers, or individual metamaterial portions of a loudspeaker, are rotatable to alter the size, and ellipse focal points, of the sound “beam” emitted by each directional acoustic loudspeaker. To form a sound wall, an embodiment selects particular directional acoustic loudspeakers that are between a minimum and maximum distance from each other. The minimum or maximum distance between directional acoustic loudspeakers depends on the height of each loudspeaker relative to the height of the noise source, the amplitude of the acoustic tone and the sharpness or blurring of the sound “beam” over a transition area where the acoustic tone is still heard with decreasing volume (e.g., a few millimeters or centimeters), reflection of the acoustic tone by the ceiling or floor, frequency spectrum and amplitude of the acoustic tone, as well as other factors.

One example of a noise control configuration is a conference area enclosed by one or more invisible sound attenuation planes (i.e., baffles, sound walls, or virtual walls), each formed using a line of directional acoustic loudspeakers in a manner described herein. In one implementation of module 220, a conference area has a static position, optionally including floor markings, light beams delineating the conference area to participants, or a status indicator indicating that noise attenuation is on or off. Another implementation of module 220 forms a conference area when triggered by one or more users speaking at a particular location for longer than a particular amount of time, for example when users gather near someone's desk for an impromptu conversation.

Another example of a noise control configuration is a noise attenuation area that fits within the sound footprint of one or a small number of directional acoustic loudspeakers (e.g., to attenuate the noise of a printer, coffee machine, ringing telephone, or a co-worker who listens to music while working). In one implementation of module 220, the noise attenuation area is static. In another implementation of module 220, the noise attenuation area moves with the noise source (e.g., to attenuate the noise of a robot vacuum cleaner or a pacing-while-speaking co-worker).

Module 220 generates an acoustic tone according to a noise control configuration, in a manner described herein, thus attenuating a detected noise source.

If module 210 detects that the noise source has altered by more than a predetermined amount (e.g., a new user has entered a conference area, an existing user has left a conference area, a conversation being attenuated has grown louder or quieter, or a moving noise source has moved to a location under a different directional acoustic loudspeaker), module 220 adjusts the existing noise control configuration and the generated acoustic tone accordingly. If module 210 detects that the noise source now has an amplitude below a predetermined threshold, module 220 ceases generating the acoustic tone.

Module 210 analyzes sound outside a noise control area, to determine in real time which frequencies are needed, how high the sound level intensity must be for each added frequency, and the width of the acoustic baffle in order to achieve the desired masking effect. To adapt to changing environmental noise, some implementations of modules 210 and 220 use one or more presently available neural network based techniques. One implementation of modules 210 and 220 uses a trained Recurrent Neural Network (RNN) or Long Short-Term Memory (LSTM) network to predict future noise conditions based on past data, enabling proactive noise masking even in environments where noise levels and types vary. Another implementation of modules 210 and 220 uses one or more natural language processing (NLP) techniques adapted to improve understanding of different types of noise through feature extraction and semantic analysis. Another implementation of modules 210 and 220 uses a reinforcement learning technique to learn the optimal parameterization for effective noise masking based on feedback from users and environmental changes (e.g., more humid, warmer air in the summer months, drier, cooler air in the winter months, air conditioning maintenance).

Loud, usually abrupt, noise source changes (e.g., shouting, clapping, or a loud argument) might not be sufficiently attenuated or masked by an embodiment. As well, a user near a sound wall might have difficulty hearing a speaker elsewhere in a conference area due to the sound of the sound wall. Thus, sound enhancement module 230 uses a microphone (e.g., a directional beam microphone), to detect audio in a particular portion of a conference area and transmits detected audio to another portion of the conference area using a directional ultrasonic speaker directly above the portion. Thus, in a large multi-participant conference area, a speaker is heard equally by all participants, regardless of distance from the speaker. One or more microphones can also be turned on or off, by a user, speaker, or automatically in response to a trigger event, for example to prevent one user's private comments from being transmitted elsewhere). Another implementation of module 230 uses a presently available trained machine translation model to translate detected audio into another language and transmits the translated audio to another portion of the conference area using a directional ultrasonic speaker directly above the portion. Another implementation of module 230 transmits detected or translated audio to a remote participant. One implementation of module 230 indicates that a microphone is actively detecting and transmitting audio using a change in the light color of the ceiling or floor lighting, or in the noise control area itself. One implementation of module 230 includes an ability to disable transmission of detected or translated audio, for privacy or other reasons.

One implementation of application 200 has access to data of a building management system, for use in managing conference and quiet zones. In the building management system, zones can be categorized as conference zone versus quiet zone, a particular type of conference zone (e.g., one for speaking and one for shouting or music), reserved versus ad-hoc (e.g., smartphone cocoon) zone, whether a zone has a static position or is moving, whether and how a zone's size is adjustable. Times of use for zones that are reserved in advance are also configurable in the building management system. The building management system uses defined confidentiality levels to indicate to an embodiment whether, for example, priority is given to speech masking (using a higher-volume sound wall) or comfort (using a lower-volume sound level, potentially reducing effective noise attenuation). The building management system contains data about registered users, for example a user's hearing or color vision disorder or preference to be considered when configuring lighting and an acoustic tone. A user profile can also include a user's acoustic fingerprint, a combination of features that characterize a user's voice, such as pitch, timbre, volume, and speaking rate, improving the efficiency and effectiveness of masking a conversation. The building management system contains data about total power consumption of noise control areas for billing purposes and to analyze and illustrate optimization potential. For example, the electricity consumption of a noise control area with a high confidentiality level will tend to be higher than that of a noise control area that is oriented towards user comfort. The building management system contains data about zone dimensions layout, and user capacity, characteristics of the room acoustics under different conditions, zone positioning (e.g., for providing “corridors” so that people and physical objects (e.g., pallets) outside a noise control area can move or be moved from one position to another without going through a noise control area), lighting conditions used to prevent people outside a noise control area from seeing private information (e.g., lip movements, gestures, slides, holograms) and whether and how a noise control area boundary should be illuminated. The building management system contains data specifying one or more installation-specific policies, such as the light color or sound indicating a noise control area boundary, a warning, a noise control area status, a maximum sound volume, what type of data is stored for what period of time, and which entities are allowed to access what level of aggregation for what purpose, minimum distances between users. The building management system also stores sensor data (e.g., from a camera or microphone) that helps determine a maintenance status of a portion of the building (e.g., dirt, dripping water, abnormal noise from the coffee machine) and, based on maintenance priorities and the layout and position of noise control areas, determines where, when and for how long robots or technicians can fix problems without disturbing people in noise control areas.

One implementation of application 200 uses one or more presently available techniques to create, optimize, and manage noise control areas with as little overlap in time and space as possible, while complying with defined building-specific requirements. For example, Linear Programming (LP), Mixed-Integer Programming (MIP), Mixed-Integer Quadratically Constrained Programming (MIQCP), Second-Order Cone Programming (SOCP), and scheduling are usable in solving multi-objective problems, e.g., when multiple, often conflicting objectives need to be optimized, such as changing team sizes with different requirements versus limited resources, or energy efficiency versus sound masking efficiency of a sound wall.

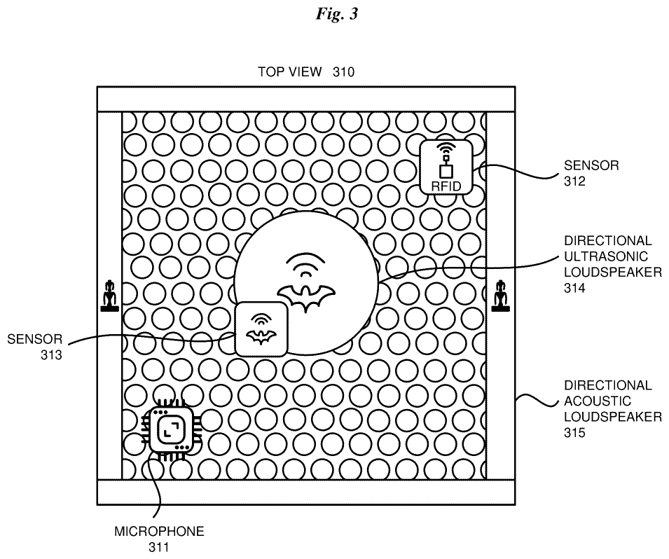

With reference to FIG. 3, this figure depicts a top view of an example configuration for an adaptive building based active noise control location in accordance with an illustrative embodiment. The example configuration can be used by application 200 in FIG. 2.

In particular, top view 310 depicts microphone 311, sensors 312 and 313, directional ultrasonic loudspeaker 314, and directional acoustic loudspeaker 315, installed in a ceiling of a building.

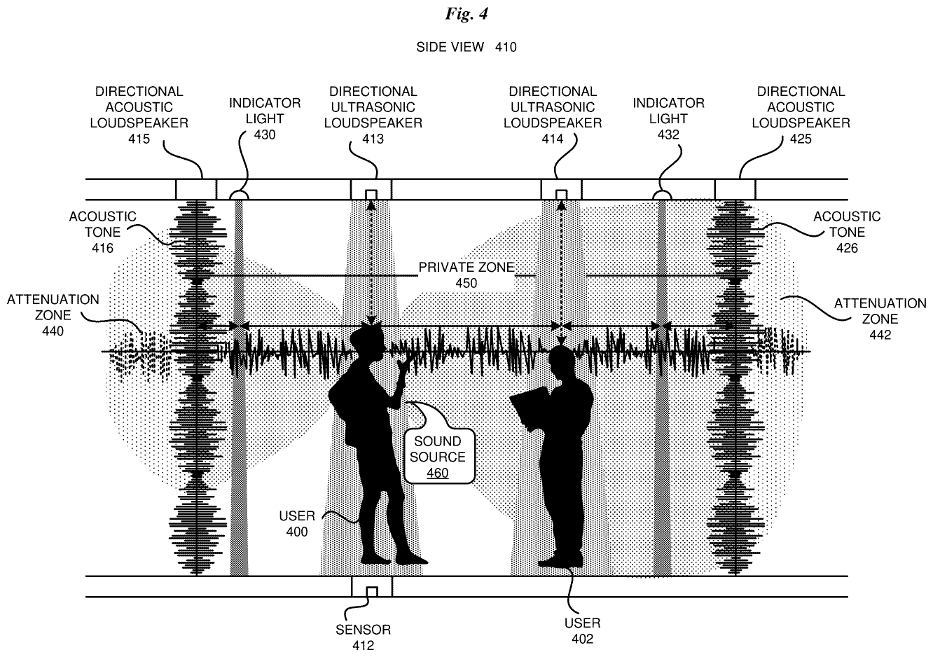

With reference to FIG. 4, this figure depicts a side view of an example configuration for an adaptive building based active noise control location in accordance with an illustrative embodiment. The example configuration can be used by application 200 in FIG. 2.

In particular, side view 410 depicts users 400 and 402 in private zone 450, a conference area. User 400 is speaking, generating sound source 460. Application 200 detects sound source 460, and configures directional acoustic loudspeaker 415, installed in the ceiling, to generate acoustic tone 416. Acoustic tone 416 interferes with, and thus attenuates, sound source 460 in attenuation zone 440. Similarly, directional acoustic loudspeaker 425, installed in the ceiling, generate acoustic tone 426, which interferes with, and thus attenuates, sound source 460 in attenuation zone 442. Indicator light 430 indicates a position of the boundary formed by acoustic tone 416, and indicator light 432 indicates a position of the boundary formed by acoustic tone 426. Module 230 uses sensor 412, a microphone, to detect audio elsewhere in the conference area, and uses directional ultrasonic loudspeaker 413 to direct the audio to user 400, and uses directional ultrasonic loudspeaker 414 to direct the audio to user 402.

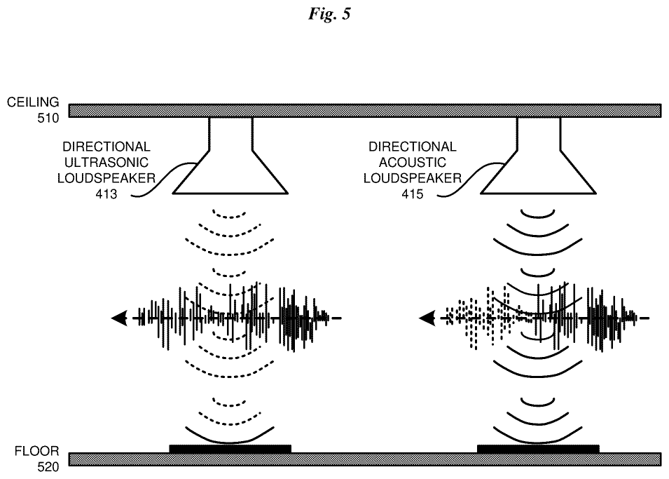

With reference to FIG. 5, this figure depicts example loudspeakers used in example configuration for an adaptive building based active noise control location in accordance with an illustrative embodiment. Directional ultrasonic loudspeaker 413 and directional acoustic loudspeaker 415 are the same as directional ultrasonic loudspeaker 413 and directional acoustic loudspeaker 415 in FIG. 4.

In particular, directional ultrasonic loudspeaker 413 and directional acoustic loudspeaker 415 are installed in ceiling 510 and are aimed at floor 520. Directional ultrasonic loudspeaker 413 modulates ultrasonic waves, which are inaudible to humans, so that the ultrasonic waves are converted into audible sound waves when the ultrasonic waves hit a surface (e.g., a user under directional ultrasonic loudspeaker 413), allowing audible sound to be directed to a specific point or area without disturbing the surrounding area. Directional acoustic loudspeaker 415 uses one or more acoustic metamaterial surfaces arranged at defined distances to achieve a defined acoustical beam with a specific focal length and direction, similar to how optical lenses adjust light waves. In contrast to the directional ultrasonic loudspeaker, the sound emitted by directional acoustic loudspeaker 415 is audible to humans.

With reference to FIG. 6, this figure depicts example loudspeakers used in example configuration for an adaptive building based active noise control location in accordance with an illustrative embodiment. Directional acoustic loudspeakers 315 are the same as directional acoustic loudspeakers 315 in FIG. 3.

In particular, FIG. 6 depicts sound “beams” emitted from directional acoustic loudspeakers 315, installed in ceiling 610, towards sound reflective floor 620, passive sound-absorbing floor 630, and active sound-absorbing floor 640 respectively.

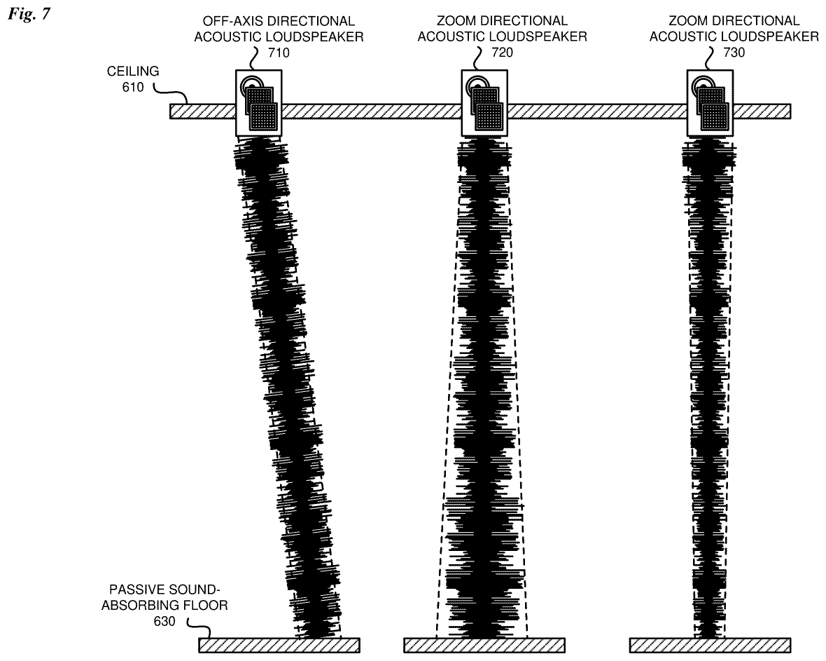

With reference to FIG. 7, this figure depicts example loudspeakers used in example configuration for an adaptive building based active noise control location in accordance with an illustrative embodiment. Ceiling 610 and passive sound-absorbing floor 630 are the same as ceiling 610 and passive sound-absorbing floor 630 in FIG. 6.

In particular, FIG. 7 depicts sound “beams” emitted from off-axis directional acoustic loudspeaker 710, zoom directional acoustic loudspeaker 720, and zoom directional acoustic loudspeaker 730, installed in ceiling 610, towards passive sound-absorbing floor 630.

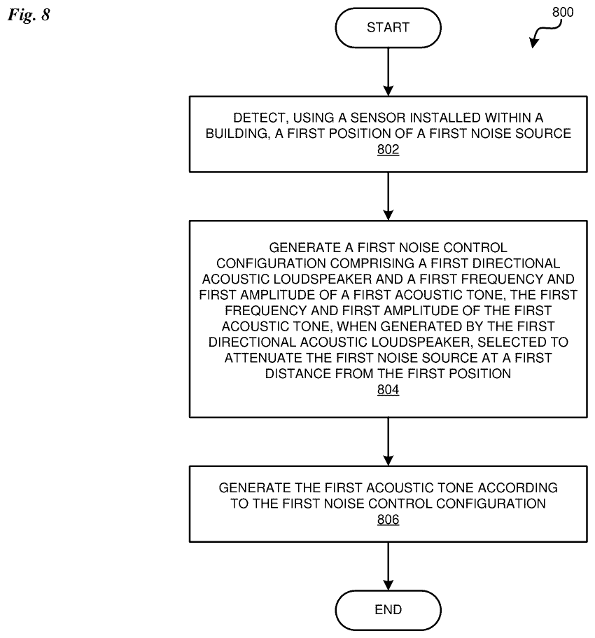

With reference to FIG. 8, this figure depicts a flowchart of an example process for an adaptive building based active noise control location in accordance with an illustrative embodiment. Process 800 can be implemented in application 200 in FIG. 2.

In the illustrated embodiment, at block 802, the process detects, using a sensor installed within a building, a first position of a first noise source. At block 804, the process generates a first noise control configuration comprising a first directional acoustic loudspeaker and a first frequency and first amplitude of a first acoustic tone, the first frequency and first amplitude of the first acoustic tone, when generated by the first directional acoustic loudspeaker, selected to attenuate the first noise source at a first distance from the first position. At block 806, the process generates the first acoustic tone according to the first noise control configuration. Then the process ends.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of +8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
detecting, using a sensor installed within a building, a first position of a first noise source;
generating a first noise control configuration comprising a first directional acoustic loudspeaker and a first frequency and first amplitude of a first acoustic tone, the first frequency and first amplitude of the first acoustic tone, when generated by the first directional acoustic loudspeaker, selected to attenuate the first noise source at a first distance from the first position; and
generating, according to the first noise control configuration, the first acoustic tone.

2. The computer-implemented method of claim 1, wherein the first noise control configuration comprises a conference area enclosed by a sound wall, the sound wall formed using a line of directional acoustic loudspeakers including the first directional acoustic loudspeaker, the line of directional acoustic loudspeakers selected from a set of directional acoustic loudspeakers installed within the building.

3. The computer-implemented method of claim 2, further comprising:
detecting, using a microphone, audio within a first portion of the conference area; and
transmitting, using a first directional ultrasonic loudspeaker, the audio to a second portion of the conference area.

4. The computer-implemented method of claim 3, further comprising:
translating, using a trained machine translation model, the audio to a second language, the translating resulting in translated audio; and
transmitting, using a second directional ultrasonic loudspeaker, the translated audio to a third portion of the conference area.

5. The computer-implemented method of claim 1, wherein the first noise control configuration comprises a noise attenuation area within a sound footprint of the first directional acoustic loudspeaker.

6. The computer-implemented method of claim 1, further comprising:
detecting, using the sensor, that the first noise source has moved to a second position;
generating, responsive to the detecting, a second noise control configuration comprising a second directional acoustic loudspeaker and a second frequency and second amplitude of a second acoustic tone, the second frequency and second amplitude of the second acoustic tone, when generated by the second directional acoustic loudspeaker, selected to attenuate the first noise source at a second distance from the second position; and
generating, according to the second noise control configuration, the second acoustic tone.

7. The computer-implemented method of claim 1, further comprising:
detecting, using the sensor, that the first noise source has altered by more than a specified amount, the altering resulting in a second noise source at the first position;
generating, responsive to the detecting, a third noise control configuration comprising the first directional acoustic loudspeaker and a third frequency and third amplitude of a third acoustic tone, the third frequency and third amplitude of the third acoustic tone, when generated by the first directional acoustic loudspeaker, selected to attenuate the second noise source at a third distance from the first position; and
generating, according to the third noise control configuration, the third acoustic tone.

8. A computer program product comprising one or more computer readable storage media, and program instructions collectively stored on the one or more computer readable storage media, the program instructions executable by a processor to cause the processor to perform operations comprising:
detecting, using a sensor installed within a building, a first position of a first noise source;
generating a first noise control configuration comprising a first directional acoustic loudspeaker and a first frequency and first amplitude of a first acoustic tone, the first frequency and first amplitude of the first acoustic tone, when generated by the first directional acoustic loudspeaker, selected to attenuate the first noise source at a first distance from the first position; and
generating, according to the first noise control configuration, the first acoustic tone.

9. The computer program product of claim 8, wherein the stored program instructions are stored in a computer readable storage device in a data processing system, and wherein the stored program instructions are transferred over a network from a remote data processing system.

10. The computer program product of claim 8, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

11. The computer program product of claim 8, wherein the first noise control configuration comprises a conference area enclosed by a sound wall, the sound wall formed using a line of directional acoustic loudspeakers including the first directional acoustic loudspeaker, the line of directional acoustic loudspeakers selected from a set of directional acoustic loudspeakers installed within the building.

12. The computer program product of claim 11, further comprising:
detecting, using a microphone, audio within a first portion of the conference area; and
transmitting, using a first directional ultrasonic loudspeaker, the audio to a second portion of the conference area.

13. The computer program product of claim 12, further comprising:
translating, using a trained machine translation model, the audio to a second language, the translating resulting in translated audio; and
transmitting, using a second directional ultrasonic loudspeaker, the translated audio to a third portion of the conference area.

14. The computer program product of claim 8, wherein the first noise control configuration comprises a noise attenuation area within a sound footprint of the first directional acoustic loudspeaker.

15. The computer program product of claim 8, further comprising:
detecting, using the sensor, that the first noise source has moved to a second position;
generating, responsive to the detecting, a second noise control configuration comprising a second directional acoustic loudspeaker and a second frequency and second amplitude of a second acoustic tone, the second frequency and second amplitude of the second acoustic tone, when generated by the second directional acoustic loudspeaker, selected to attenuate the first noise source at a second distance from the second position; and
generating, according to the second noise control configuration, the second acoustic tone.

16. The computer program product of claim 8, further comprising:
detecting, using the sensor, that the first noise source has altered by more than a specified amount, the altering resulting in a second noise source at the first position;
generating, responsive to the detecting, a third noise control configuration comprising the first directional acoustic loudspeaker and a third frequency and third amplitude of a third acoustic tone, the third frequency and third amplitude of the third acoustic tone, when generated by the first directional acoustic loudspeaker, selected to attenuate the second noise source at a third distance from the first position; and
generating, according to the third noise control configuration, the third acoustic tone.

17. A computer system comprising a processor and one or more computer readable storage media, and program instructions collectively stored on the one or more computer readable storage media, the program instructions executable by the processor to cause the processor to perform operations comprising:
detecting, using a sensor installed within a building, a first position of a first noise source;
generating a first noise control configuration comprising a first directional acoustic loudspeaker and a first frequency and first amplitude of a first acoustic tone, the first frequency and first amplitude of the first acoustic tone, when generated by the first directional acoustic loudspeaker, selected to attenuate the first noise source at a first distance from the first position; and
generating, according to the first noise control configuration, the first acoustic tone.

18. The computer system of claim 17, wherein the first noise control configuration comprises a conference area enclosed by a sound wall, the sound wall formed using a line of directional acoustic loudspeakers including the first directional acoustic loudspeaker, the line of directional acoustic loudspeakers selected from a set of directional acoustic loudspeakers installed within the building.

19. The computer system of claim 18, further comprising:
detecting, using a microphone, audio within a first portion of the conference area; and
transmitting, using a first directional ultrasonic loudspeaker, the audio to a second portion of the conference area.

20. The computer system of claim 19, further comprising:
translating, using a trained machine translation model, the audio to a second language, the translating resulting in translated audio; and
transmitting, using a second directional ultrasonic loudspeaker, the translated audio to a third portion of the conference area.
